(19) United States
(12) Patent Application Publication
(10) Pub. No.: US 2015/0160252 A1
(43) Pub. Date: Jun. 11, 2015

(54) METHOD AND APPARATUS FOR DETECTING POSITION OF LIQUID SURFACE, LIQUID SUPPLY APPARATUS, AND ANALYZING SYSTEM

(71) Applicant: CANON KABUSHIKI KAISHA, Tokyo (JP)

(72) Inventor: Yoichi Murakami, Newport News, VA (US)

(21) Appl. No.: 14/559,647

(22) Filed: Dec. 3, 2014

(30) Foreign Application Priority Data
Dec. 5, 2013 (JP) 2013-252551

(51) Int. Cl. G01N 35/10; G01N 21/76; G01N 21/11; G01F 23/292

(52) U.S. Cl. CPC G01N 35/1016; G01F 23/292; G01N 21/76; G01N 21/11; G01N 35/1011; G01N 2201/061; G01N 2201/02; G01N 2035/1025

(57) ABSTRACT

A method of measuring a position of a liquid surface in a light transmissive container, includes:
irradiating a liquid surface with light obliquely so the light is transmitted through an inner wall that comes into contact with liquid and is totally reflected from an inner wall that comes into contact with air in the state in which a light-receiving surface is present on a bottom portion of the container; and detecting a position of a boundary between a dark portion and a bright portion generated by the total reflection on the light-receiving surface.

### BACKGROUND

1. Field of the Invention

This disclosure relates to a method of detecting a position of the liquid surface of liquid arranged in a light transmissive container.

2. Description of the Related Art

In recent years, a research development on a technology referred to as a micro total analysis system (μ-TAS) that integrates all elements required for chemical or biochemical analyses on one single chip prevails. The chip includes a micro flow channel, a reagent retaining mechanism, a temperature control mechanism, a liquid feeding mechanism, and a reaction detecting mechanism, and is referred to as a micro fluid device.

Normally, the reagent retaining mechanism is integrated into the device. However, in the case where a relatively larger amount of reagent of a micro litter order is required for performing inspection repeatedly, the reagent is normally dispensed from an external well such as a micro plate. In such a case, the reagent in the external well is sucked by using a pipette robot, and is discharged into the reagent retaining mechanism of the micro fluid device, whereby dispense of the reagent is achieved.

Here, if the pipette robot dispenses the reagent in the well repeatedly, there arises a problem of fluctuation of the amount of reagent to be dispensed. FIGS. 8A and 8B are schematic drawings illustrating a change in amount of liquid suction by a pipette chip before and after lowering of a height of the liquid surface in a container 51. In FIG. 8A, liquid is filled in the pipette from a distal end of the chip, which is at a distance h₁ from a liquid surface, up to a height of H from the distal end. Subsequently, assuming that the distance from the liquid surface to the distal end of the chip is lowered to h₂ by dispensation as illustrated in FIG. 8B, and a lowering amount ΔH of the height of the liquid surface in the pipette chip at this time is obtained. Where ρ_{w} is a density of liquid 52, P is a constant control pressure of the liquid surface in the pipette chip, T is a force (capillary force) that the liquid rises the pipette chip by a capillary force, s is a cross-sectional area of the pipette chip, and g is a gravitational acceleration, the following expression (1) is obtained from a balance of a force applied to liquid in the pipette chip in FIG. 8A,

ρ_{w}g(H−h₁)s=P+T (1)

Also, from a balance of a force applied to the liquid in the pipette chip in FIG. 8B, the following expression (2) is obtained.

ρ_{w}g(H−ΔH−h₂)s=P+T (2)

When putting the expressions (1) and (2) together, following equation is satisfied.

ΔH=h₁−h₂ (3)

From the description given above, it is understood that the liquid surface level in the pipette chip is lowered by an amount corresponding to the lowering of the height of the liquid surface in the well. In other words, even though the reagent is dispensed by controlling the control pressure P of the pipette to be constant with high degree of accuracy, the amount of reagent to be sucked is disadvantageously reduced as the liquid surface is lowered by dispensing repeatedly.

An effective method of solving the problem described above includes measuring the position of the liquid surface, and mechanically adjusting the position of the distal end of the pipette in accordance with the position of the measured liquid surface or adjusting the control pressure P.

There are two types of methods in measurement of the position of the liquid surface, namely, a contact type and a non-contact type. Specifically in the case of handling a minute amount of liquid, it is required to avoid an influence of contamination, so that the non-contact type is more desired.

As the non-contact type position of the liquid surface measuring method, a method of measuring a position of a liquid surface by irradiating an opening of a tin container with light from above and taking an image of an upper end portion of the liquid surface from an upper end portion of the tin with a camera is disclosed (see Japanese Patent Laid-Open No. 9-218077).

A method of installing a liquid level gauge in advance in a container and detecting the position of the liquid surface from a visual difference between an interior of liquid and an exterior of liquid due to a total reflection of light is also disclosed (see Japanese Patent Laid-Open No. 2008-292364).

None of methods for detecting the liquid surface described above is suitable for measuring the liquid surface in a container having a small capacity such as a micro plate.

For example, in the method of taking the image of the upper end portion of the liquid surface with the camera and monitoring the position of an air-liquid interface, contrast cannot be obtained with a transparent container, so that detection of the liquid surface is difficult as in Japanese Patent Laid-Open No. 9-218077.

Also, it is difficult to install a liquid level gauge in a small container of a milliliter or microliter order such as a micro plate as in Japanese Patent Laid-Open No. 2008-292364, respectively. In addition, in the case where a large number of types of liquid are required to be handled such as an analysis of a large number of test bodies, deterioration caused by washing for reuse occurs often, and an increase in cost is inevitable in the case where it is configured to be disposable.

### SUMMARY

This disclosure provides a method of detecting a position of the liquid surface in a container being transparent and having a small capacity easily.

A method of detecting a position of the liquid surface of this disclosure is
a method of measuring a position of the liquid surface in a light transmissive container, including:
irradiating a liquid surface with light obliquely so the light is transmitted through an inner wall that comes into contact with liquid and is totally reflected from an inner wall that comes into contact with air in the state in which a light-receiving surface is present on a bottom portion of the container; and detecting a position of a boundary between a dark portion and a bright portion generated by the total reflection on the light-receiving surface.

A method of measuring a position of the liquid surface of this disclosure is a method of measuring a position of the liquid surface of liquid arranged in a container having a side wall surface formed of a light transmissive material, including: irradiating the liquid surface with light from obliquely above so that a first light incoming from a light source into the liquid surface without the intermediary of the light transmissive material and a second light entering into the liquid after the transmission through the light transmissive material both reach the light-receiving surface arranged on a bottom portion of the container; and measuring a length of a dark portion between the first light and the second light generated by the total reflection of the light at a position where the light transmissive material comes into contact with atmospheric air.

According to this disclosure, the position of the liquid surface may be measured easily also in the light transmissive container having a small capacity.

Further features of the present invention will become apparent from the following description of exemplary embodiments with reference to the attached drawings.

### BRIEF DESCRIPTION OF THE DRAWINGS

FIGS. 1A and 1B are general configuration drawings for executing a method of measuring a position of the liquid surface of this disclosure.

FIGS. 2A to 2D are conceptual drawings illustrating routes of light from a light source until reaching a light-receiving surface.

FIG. 3 is a conceptual drawing illustrating a relationship between the position of the liquid surface and a length of a dark portion.

FIGS. 4A and 4B are general configuration drawings illustrating a container having a plurality of wells.

FIG. 5 is a schematic drawing illustrating a configuration of a liquid supply apparatus.

FIG. 6 is a schematic drawing illustrating a configuration of an analyzing system.

FIG. 7 is a schematic drawing illustrating a light transmissive container used in the example.

FIGS. 8A and 8B are schematic drawings illustrating a change in amount of liquid suction by a pipette chip before and after the lowering of the position of the liquid surface.

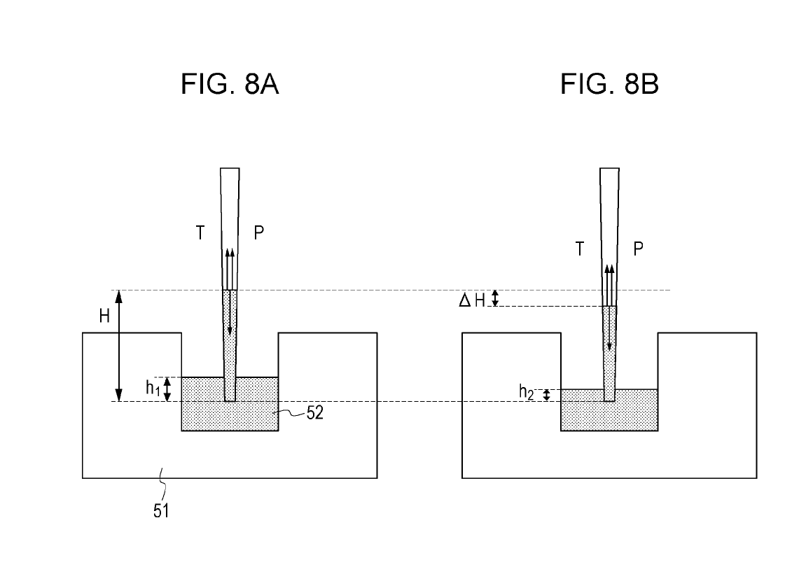

### DESCRIPTION OF THE EMBODIMENTS

Referring now to the drawings, embodiments of this disclosure will be described.

### First Embodiment: Method of Measuring Height of Liquid Surface and Apparatus for Measuring Liquid Surface

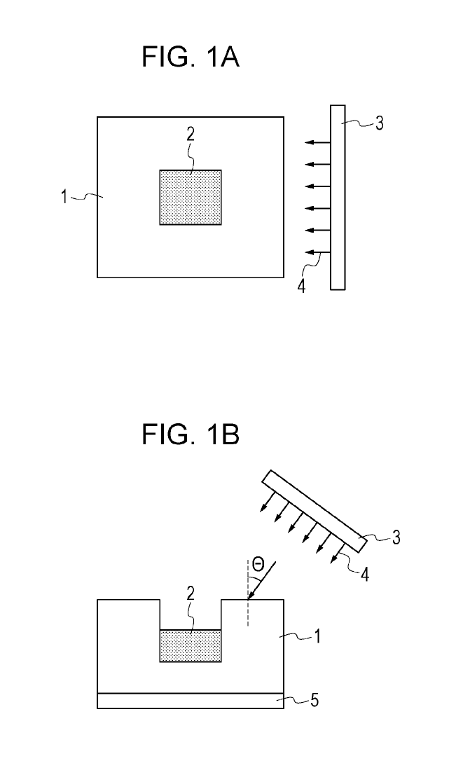

FIGS. 1A and 1B are drawings illustrating a general configuration for executing a method of measuring a position of the liquid surface of a first embodiment. FIG. 1A is a top view, and FIG. 1B is a vertical cross-sectional view. Liquid 2 is filled in a light transmissive container 1, and a light source 3 provided obliquely above the light transmissive container 1. Light 4 emitted from the light source 3 reaches a light-receiving surface 5 arranged so as to come into contact with a bottom surface of the light transmissive container. The light-receiving surface 5 is formed of a light-receiving device such as a CCD, and serves also as a placing device for placing the container 1 thereon.

Here, in order to prevent the light 4 emitted from the light source 3 as an irradiating device from totally reflecting from an interface between a side wall surface of the irradiating device and the liquid 2, the light source 3 is installed so that an incident angle θ₁ of the light 4 onto an upper surface of the light transmissive container satisfies the following expression (4). In the expression, n₁ is a refractive index of air, n₂ is a refractive index of the light transmissive container, and n₃ is a refractive index of the liquid.

$$\frac{{n}_{2}}{{n}_{3}} cos \{ {sin}^{- 1} ( \frac{{n}_{1}}{{n}_{2}} sin {θ}_{1} ) \} \leq 1 \qquad ( 4 )$$

The light transmissive container 1 needs only to be configured to allow the light to reach the light-receiving surface present on the bottom surface of the container by the irradiation from the light source and is a transparent or opaque container. A material of the container is not specifically limited and may be plastic, glass, and the like. Hereinafter, description will be given by using a transparent container.

One or a plurality of depressed portions may be arranged for infusing the liquid 2.

A process that forms the depressed portions is preferably selected from injection molding, mechanical processing, and the like depending on the material. The capacity of the transparent container is not specifically limited. However, provision of the well having a capacity of 0.01 μL to 1000 μL, preferably, a capacity of 0.1 μL to 100 μL, for example, is preferable.

The light source 3 is not specifically limited and may be an LED, a laser, a point light source, a surface light source, and the like. However, the point light source which provides a substantially constant light incident angle to a wall surface of the depressed portion or the surface light source which emits parallel light are preferable.

A sensor used for the light-receiving surface 5 is not specifically limited and may be a line sensor, an area sensor, and the like as long as the sensor may identify a position of a boundary between a bright portion and a dark portion of an illuminated light beam.

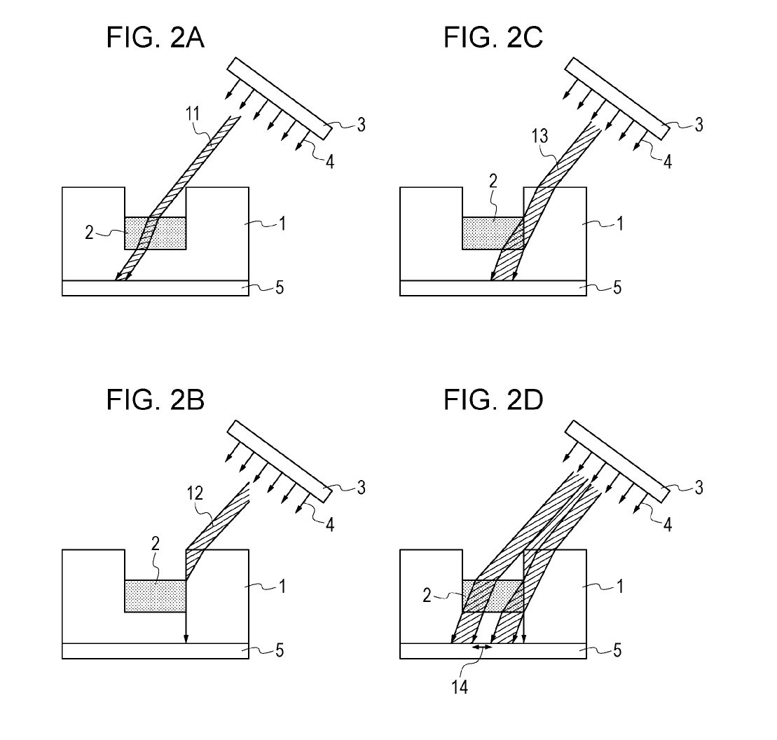

Subsequently, principles of this disclosure will be described. FIGS. 2A to 2D are conceptual drawings illustrating routes of the light 4 from the light source 3 until reaching the light-receiving surface 5 when measuring the position of the liquid surface of this disclosure. The light source 3 is assumed to be the surface light source configured to radiate light at a constant angle with respect to the transparent container 1. A route 11 in FIG. 2A indicates a route of the light 4 incident on the liquid 2 without the intermediary of an upper surface of the transparent container 1 and reaching the light-receiving surface 5.

A route 12 in FIG. 2B indicates a route of the light 4 of the case where the light 4 is incident on the upper surface of the transparent container 1, and then is incident on an interface on a side wall surface of the transparent container 1 between an upper end of the container 1 and the liquid surface. The light passing through the route 12 reflects totally from an interface between the transparent container and atmosphere because of the refractive index thereof, and hence cannot go out from the transparent container and directly reaches the light-receiving surface 5.

A route 13 in FIG. 2C indicates a route of the light 4 incident on the upper surface of the transparent container 1, and then is transmitted through a portion of the transparent container 1 lower than the liquid surface.

FIG. 2D is a conceptual drawing illustrating a dark portion 14 formed on the light-receiving surface by the routes 11, 12, and 13. The light passing through the route 12 reaching the interface from the upper end of the container to the liquid surface reflects totally from the interface, and hence the dark portion 14 is formed between the light passing through the route 11 and the light passing through the route 13.

The position of the liquid surface may be measured by measuring the length of the dark portion 14 by the light-receiving surface 5, and converting the measured length into a height from the upper end of the transparent container 1 to the liquid surface by using an expression (5) described below.

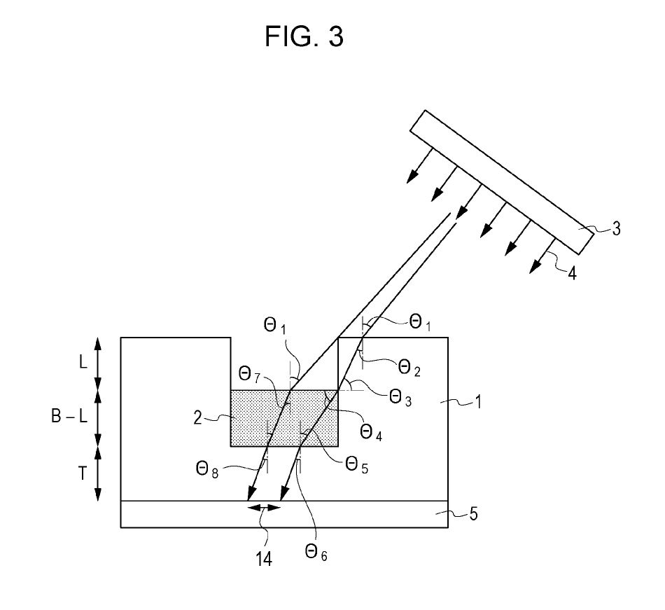

FIG. 3 is a conceptual drawing illustrating a relationship between the position of the liquid surface and the length of the dark portion. With reference to the upper surface of the container, L is a height from the upper surface to the liquid surface, B is a depth of the container, T is a distance from the bottom surface of the container to the light-receiving surface, D is a length of the dark portion, θ₁ is an incident angle of the light 4 with respect to the upper surface of the transparent container, n₁ is a refractive index of air, n₂ is a refractive index of the transparent container, and n₃ is a refractive index of the liquid. The light incident angle and angles of refraction at the respective interfaces are as illustrated in FIG. 3. At that time, the dark portion length D is expressed by the following expression (5).

D=L(tan θ₁−tan θ₇+tan θ₅)+B(tan θ₇−tan θ₅)+T(tan θ₈+tan θ₆) (5)

Here, the incident angles θ₂ to θ₈ of light may be expressed by the known incident angle θₗ from Snell's law. Therefore, the height L of the liquid surface may be obtained by obtaining the dark portion length D. The case where the surface light source, that is, the light incident angle with respect to the transparent container 1 is constant at θ₁ has been described. However, the dark portion length D may be identified in the same manner as the case of the surface light source by changing the value of θ₁ depending on the position of irradiation in the case of the point light source.

In other words, by irradiating the liquid surface with light obliquely so that the light is transmitted through an inner wall that comes into contact with the liquid, and is reflected totally from an inner wall that comes into contact with air, the position of the boundary between the dark portion and the bright portion generated by the total reflection is detected by the light-receiving surface.

With the process of irradiating the liquid surface with light from obliquely above so that a first light incoming from the light source into the liquid surface without the intermediary of the light transmissive material and a second light entering into the liquid after the transmission through the light transmissive material reach the light-receiving surface arranged on the bottom portion of the container, and the process of measuring a length of a dark portion between the first light and the second light generated by the total reflection of the light at a position where the light transmissive material comes into contact with atmospheric air, the height information with reference to the position of the liquid surface, specifically, the upper surface of the container may be obtained accurately.

The method of measuring and the apparatus for measuring the position of the liquid surface according to this disclosure also has an advantage that the information on the position of the liquid surfaces of the plurality of wells may be obtained easily at the same time or consecutively, or at once by the same light source and the light-receiving device.

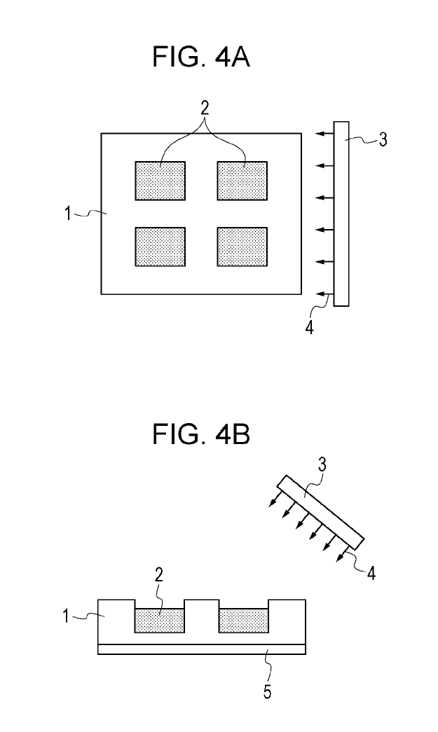

As illustrated in FIG. 4, even though the plurality of wells are arranged in parallel, the position of the liquid surfaces may be obtained simultaneously by obtaining the value of θ₁ depending on the relationship of the irradiating positions as described above.

According to this method, the position of the liquid surface in the light transmissive container may be detected.

The light transmissive container only has to have light transmissive property at a portion required for detecting the position of the liquid surface. However, the transparent container such as a micro plate formed entirely of the transparent container is preferable. In this case, the light-receiving surface may be arranged so as to come into contact with the bottom surface of the transparent container. In other words, a configuration in which the light-receiving device having the light-receiving surface on a placing portion on which the transparent container is to be placed is preferable.

However, the light-receiving surface needs only to be present on a bottom portion of the container and, for example, the light transmissive container formed by adhering a transparent member having a through hole, for example, and a bottom member having a light-receiving surface and forming the depressed portion is also applicable.

### Second Embodiment: Liquid Supply Apparatus

As described above, by measuring the position of the liquid surface in the container, that is, the height of the liquid surface, a liquid supply with high degree of accuracy may be realized by simple control of the pipette robot.

Hereinafter, a liquid supply apparatus 19 will be described in detail.

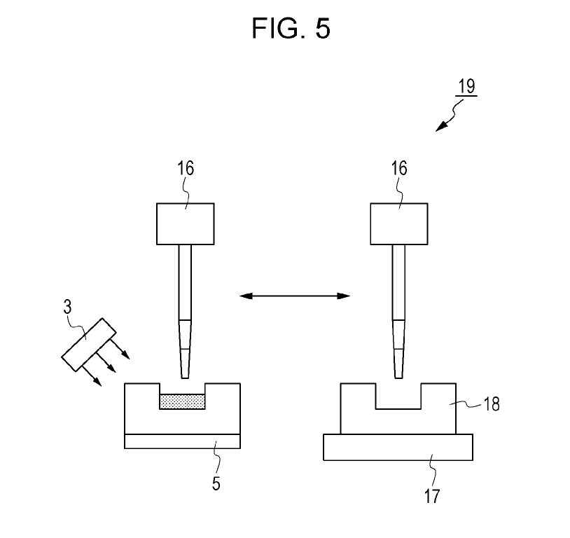

FIG. 5 is a drawing illustrating the liquid supply apparatus 19 of a second embodiment. Reference numeral 15 denotes a liquid surface measuring apparatus (having the light source 3 and the light-receiving surface 5) described in the first embodiment. Reference numeral 16 denotes a pipette robot having a pipette for sucking liquid from the container and movable in a vertical direction or a horizontal direction. Reference numeral 17 denotes a base.

As a control device for the pipette, at least one of a device configured to adjust an amount of suction of the pipette in accordance with the position of the liquid surface, a device configured to adjust the height of the pipette in accordance with the position of the liquid surface, and a device configured to adjust the position of the container in accordance with the position of the liquid surface is preferably provided.

As described in the first embodiment, since the height of the liquid surface such as reagent or a test body arranged in the container is accurately measured, an accurate liquid suction is achieved by controlling the position of the pipette or the container as in examples described later.

Accordingly, liquid of an accurate amount may be supplied to a different analyzing device such as a micro plate 18 or a μ-TAS.

### Third Embodiment: Analyzing System

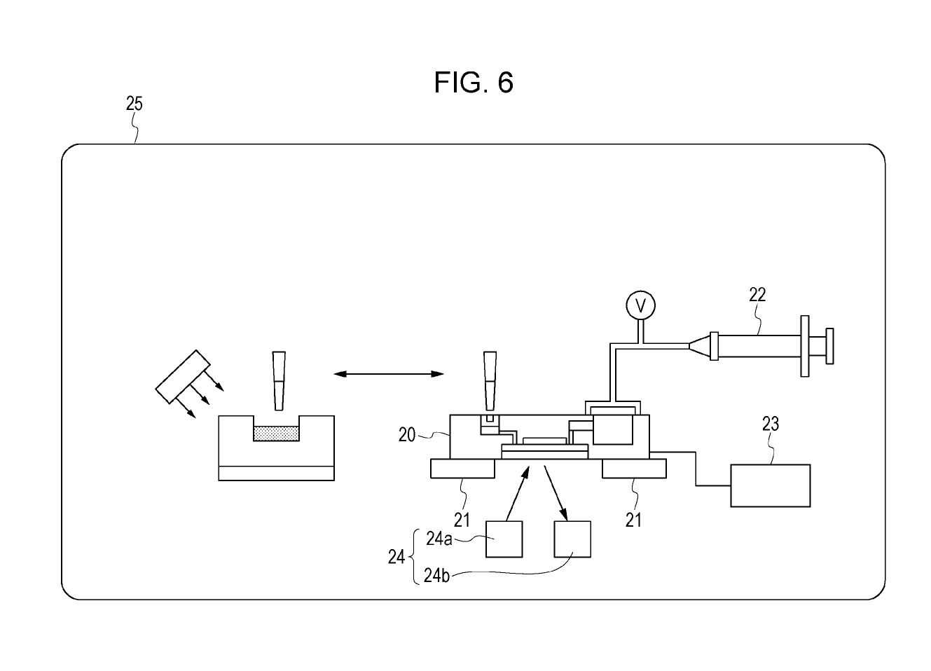

A third embodiment provides an analyzing system as illustrated in FIG. 6.

An analyzing system 25 includes the liquid supply apparatus 19 illustrated in the second embodiment, base portions 21 on which a fluid device 20 is to be placed, and a liquid control mechanism 22 configured to control liquid in the fluid device. In addition, as a processing device, a voltage control unit 23 configured to control an electrode (or a heater) for causing chemical or biochemical reaction in the fluid device is provided.

Furthermore, a signal detecting unit 24 configured to detect a signal such as fluorescent light emission generated as a result of reaction is provided. The signal detecting unit includes, for example, a light irradiation section 24a and a light detecting portion 24b, and is configured to detect fluorescent light emitted as a result of irradiation of the sample present in the fluid device with light.

Specifically, this analyzing system is capable of causing a PCR reaction process by supplying, for example, a mixture of a nucleic acid of the test body as a target of analysis and PCR reagent into the fluid device and applying a temperature cycle to the heater. The PCR reaction may be detected by the fluorescent reagent contained in the PCR reagent as an increase in fluorescent amount.

In the third embodiment, the pipette robot is capable of supplying the liquid to the fluid device always by extremely accurate amount, which contributes to improvement of reliability of analysis.

### EXAMPLES

With reference to examples, this disclosure will be described in further detail. The following examples are intended to describe this disclosure in detail, and the embodiments are not limited by the following examples.

In the examples, the case of sucking the liquid repeatedly will be described. Specifically, these examples show that the dispensing amount may be uniformized even after the repeated dispensation by measuring the height of the liquid surface immediately before sucking the liquid, and adjusting the position of a distal end of the pipette of the pipette robot.

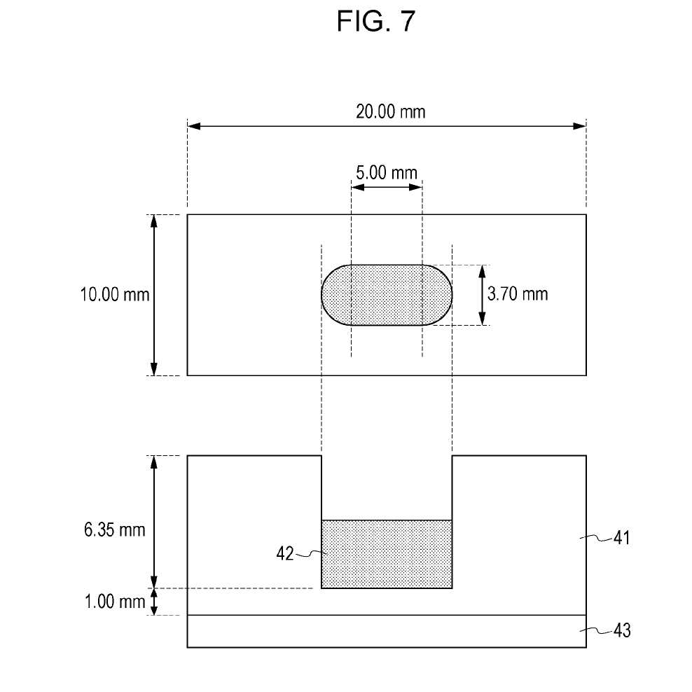

FIG. 7 is a schematic drawing illustrating a transparent container used in the examples. In the examples, liquid 42 was infused in a transparent container 41 as illustrated in FIG. 7 and the liquid was dispensed by using the pipette robot (not illustrated).

The transparent container 41 was manufactured by injection-molding acrylic (refractive index: 1.49). The outer dimension and the inner dimension were as illustrated in FIG. 7. A line sensor was installed as a light-receiving surface 43 on a bottom surface of the transparent container 41. The resolution of the line sensor was 0.1 mm. An LED was used as a light source (not illustrated), and an incident angle of light to the transparent container was set to 50°.

50 μL of liquid was dispensed in advance into the transparent container 41. Actions of sucking the liquid 42 in the transparent container 41 by using the pipette robot, and repeatedly dispensing to a chemical scale were performed. Then, the mass of the liquid 42 dispensed on the chemical scale was measured, and was converted into the volume, whereby variations in sucked volume by the pipette was evaluated. The pipette chip used here was 20 μL size (0.7 mm² in inner cross-sectional area), and the preset amount of suction by the pipette was 3 μL per stroke.

### Comparative Example 1

As a comparative example of this disclosure, the case where the liquid 42 was repeatedly sucked without measuring the height of the liquid surface will be described.

First of all, the position of a distal end of the pipette chip was set so as to submerge by approximately 2.0 mm from the liquid surface in the transparent container 41, and a repeated dispensation was performed. Consequently, 3.0 μL was measured by one stroke of dispensation for the first time, but the dispensing amount was reduced by 0.1 μL every time where the dispensation is repeated. Then, when the dispensation was repeated by four times, the dispensing amount is reduced by 0.3 μL, and hence the dispensing amount was 2.7 μL, which was 10% less.

### Example 1

In Example 1, the height of the liquid surface was measured, the amount of suction was adjusted correspondingly, and dispensation was performed repeatedly.

First of all, the height of the liquid surface was measured by the method described above before the first dispensation. Consequently, the length of the dark portion formed on the light-receiving surface was 6.0 mm, and the liquid surface before the dispensation was found to be at a position of 3.1 mm from the bottom surface of the container. Accordingly, the distal end of the pipette chip was set to a position at 1.1 mm from the bottom surface of the container, and the first dispensation was performed. The result was 3.0 μL. As a result of measurement of the height of the liquid surface by the method of measurement of this disclosure after the first dispensation has been terminated, the liquid surface was at a position of 2.9 mm from the bottom surface of the container. As described in Description of Related Art, since the amount of suction of the pipette is directly affected by a change in height of the liquid surface in the container, the dispensation was performed with the amount of suction increased by the inner cross-sectional area of the pipette chip, 0.7 mm²×0.2 mm (≈0.1 μL), and the amount of suction of the pipette set to 3.1 μL. Consequently, as a result of measurement after the second dispensation has performed, the amount was 3.0 μL. The dispensing amount could be maintained at 3.0 μL even after four times of repetition of the action described above.

In this manner, by measuring the height of the liquid surface and adjusting the amount of suction before the dispensation, the uniform dispensation could be repeated. Example 2

In Example 2, the height of the liquid surface was measured, the height of the pipette was adjusted correspondingly, and dispensation was performed repeatedly.

First of all, the height of the liquid surface was measured by the method described above before the first dispensation. Consequently, the length of the dark portion formed on the light-receiving surface was 6.0 mm, and the liquid surface before the dispensation was found to be at a position of 3.1 mm from the bottom surface of the container. Accordingly, the distal end of the pipette chip was set to a position at 1.1 mm from the bottom surface of the container, and the first dispensation was performed. The result was 3.0 μL. As a result of measurement of the height of the liquid surface by the method of measurement of this disclosure after the first dispensation has been terminated, the liquid surface was at the position of 2.9 mm from the bottom surface of the container, which is 0.2 mm lower than the initial position. Therefore, in order to align the position of the distal end of the pipette chip with respect to the height of the liquid surface, the distal end of the pipette chip was set to a position of 0.9 mm, which is 0.2 mm lower than the initial position, namely, 1.1 mm from the bottom surface of the container, and the second dispensation was performed. Consequently, as a result of measurement after the second dispensation has performed, the amount was 3.0 μL. The dispensing amount could be maintained at 3.0 μL even after four times of repetition of the action described above.

In this manner, by measuring the height of the liquid surface and adjusting the height of the position of the distal end of the pipette chip with respect to the height of the liquid surface to be uniform before the dispensation, the uniform dispensation could be repeated. Example 3

In Example 3, the height of the liquid surface was measured, the position of a well plate was adjusted correspondingly, and dispensation was performed repeatedly.

First of all, the height of the liquid surface was measured by the method described above before the first dispensation. Consequently, the length of the dark portion formed on the light-receiving surface was 6.0 mm, and the liquid surface before the dispensation was found to be at a position of 3.1 mm from the bottom surface of the container. Accordingly, the distal end of the pipette chip was set to a position at 1.1 mm from the bottom surface of the container, and the first dispensation was performed. The result was 3.0 μL. As a result of measurement of the height of the liquid surface by the method of measurement of this disclosure after the first dispensation has been terminated, the liquid surface was at a position of 2.9 mm from the bottom surface of the container, which is 0.2 mm lower than the initial position. Therefore, by rising the position of the well plate by 0.2 mm, the position of the distal end of the pipette with respect to the liquid surface was adjusted to be identical as the first stroke. Then the second dispensation was performed. Consequently, as a result of measurement after the second dispensation has performed, the amount was 3.0 μL. The dispensing amount could be maintained at 3.0 μL even after four times of repetition of the action described above.

In this manner, by measuring the height of the liquid surface and adjusting the position of the well before the dispensation, the uniform dispensation could be repeated.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-252551 filed Dec. 5, 2013 which is hereby incorporated by reference herein in its entirety.

What is claimed is:

1. A method of measuring a position of a liquid surface in a light transmissive container, comprising:
irradiating the liquid surface with light obliquely so the light is transmitted through an inner wall that comes into contact with liquid and is totally reflected from an inner wall that comes into contact with air in the state in which a light-receiving surface is present on a bottom portion of the container; and
detecting a position of a boundary between a dark portion and a bright portion generated by the total reflection on the light-receiving surface.

2. A method of measuring a position of the liquid surface of the liquid arranged in a container having a side wall surface formed of a light transmissive material, comprising:
irradiating the liquid surface with light from obliquely above so a first light incoming from a light source into the liquid surface without the intermediary of the light transmissive material and a second light entering into the liquid after the transmission through the light transmissive material reach the light-receiving surface arranged on a bottom portion of the container and are reflected totally at a position where the light transmissive material comes into contact with atmospheric air; and measuring the length of a dark portion between the first light and the second light.

3. A method according to claim 2, wherein where θ₁ is an incident angle of light with respect to an upper surface of the container, n₁ is a refractive index of air, n₂ is a refractive index of the container, and n₃ is a refractive index of liquid, the light is caused to be incident at the incident angle (θ₁) which satisfies the following expression:
$$\frac{{n}_{2}}{{n}_{3}} cos \{ {sin}^{- 1} ( \frac{{n}_{1}}{{n}_{2}} sin {θ}_{1} ) \} \leq 1.$$

4. The method according to claim 2, wherein the position of the liquid surface corresponds to a height of the liquid surface with reference to an upper surface of the container.

5. The method according to claim 4, wherein dispensation is preformed while adjusting an amount of suction in accordance with the height of the liquid surface.

6. The method according to claim 4, wherein dispensation is performed while adjusting the height of the pipette in accordance with the height of the liquid surface.

7. The method according to claim 4, wherein a dispensation is performed while adjusting the position of the container in accordance with the height of the liquid surface.

8. The method according to claim 1, wherein the container is a micro plate having a plurality of wells.

9. An apparatus configured to detect a position of a liquid surface of liquid arranged in a container having a side wall surface formed of a light transmissive material, comprising:
a placing device on which the container is placed;
an irradiating device configured to irradiate the container with light; and
a light-receiving device having a light-receiving surface provided on the placing device, wherein
the irradiating device is a device configured to irradiate the liquid surface with light obliquely so the light is transmitted through an inner wall that comes into contact with the liquid and is reflected totally from an inner wall that comes into contact with air, and
a position of a boundary between a dark portion and a bright portion generated by the total reflection is detected by the light-receiving surface.

10. The apparatus according to claim 9, wherein
the irradiating device is a device configured to irradiate the liquid surface with light from obliquely above so that a first light incoming from the device into the liquid surface without the intermediary of the light transmissive material and a second light entering into the liquid after the transmission through the light transmissive material reach the light-receiving device arranged on a bottom portion of the container; and
a height of the liquid surface is obtained by measuring a length of a dark portion between the first light and the second light generated by the total reflection of the light at a position where the light transmissive material comes into contact with atmospheric air on the light-receiving surface.

11. A liquid supply apparatus configured to supply liquid, comprising:
the apparatus according to claim 9; and
a pipette robot having a pipette for sucking liquid from the container.

12. The liquid supply apparatus according to claim 11, comprising a device configured to adjust an amount of suction of the pipette in accordance with the position of the liquid surface.

13. The liquid supply apparatus according to claim 11 comprising: a device configured to adjust a height of the pipette in accordance with the position of the liquid surface.

14. The liquid supply apparatus according to claim 11, comprising a device configured to adjust a position of the container in accordance with the position of the liquid surface.

15. An analyzing system for analyzing a sample by using a fluid device comprising:
a device on which the fluid device is to be placed;
a processing device configured to process liquid in the fluid device; and
the liquid supply apparatus according to claim 11.
